(19) United States
(12) Patent Application Publication
(10) Pub. No.: US 2016/0161718 A1
(43) Pub. Date: Jun. 9, 2016

(54) IMAGING OPTICAL SYSTEM

(71) Applicant: HOYA CORPORATION, Tokyo (JP)

(72) Inventor: Daisuke KOREEDA, Saitama (JP)

(73) Assignee: HOYA CORPORATION, Tokyo (JP)

(21) Appl. No.: 14/947,362

(22) Filed: Nov. 20, 2015

(30) Foreign Application Priority Data
Dec. 5, 2014 (JP) 2014-247242

(51) Int. Cl. G02B 13/00; G02B 9/60; G02B 27/00; G02B 1/04

(52) U.S. Cl. CPC G02B 13/0045; G02B 1/041; G02B 9/60; G02B 27/0025

(57) ABSTRACT

An imaging optical system includes a positive first lens element having a convex surface on the object side, a negative second lens element having a concave surface on the image side, a third lens element, a positive fourth lens element, and a negative fifth lens element provided with at least one aspherical surface that has inflection points other than at an optical axis thereof. The following conditions (1) and (2) are satisfied:

−0.80<(r11−r12)/(r11+r12)<−0.20 (1),

and

νd1>60 (2),

wherein r11 and r12 designate the radius of curvatures of surfaces on the object side and image side of the first lens element, respectively, and νd1 designates the Abbe number with respect to the d-line of the first lens element.

### BACKGROUND OF THE INVENTION

1. Field of the Invention

The present invention relates to an imaging optical system, e.g., an imaging optical system that is installed in a mobile device (a smart phone, etc.) having a built-in camera.

2. Description of Related Art

Patent Literature Nos. 1 through 3 each disclose an imaging optical system installed in, e.g., a mobile device, having a built-in camera, which provides an f-number of approximately 1.9 through 2.8 and a half angle-of-view of 35 degrees or more.

The imaging optical system in each of Patent Literature Nos. 1 through 3 has a configuration of five lens elements, in which a positive lens element is provided closest to the object side, and a positive lens element or a negative lens element that has an aspherical surface having inflection points other than at the optical axis (at positions other than at an intersection point of the optical axis) is provided closest to the image side.

Patent Literature 1: Japanese Unexamined Patent Application No. 2014-182298

Patent Literature 2: Japanese Unexamined Patent Application No. 2014-44443

Patent Literature 3: Japanese Unexamined Patent Application No. 2013-225159

However, since the imaging optical system in each of Patent Literature Nos. 1 through 3 has an inappropriate lens profile and/or chromatic dispersion (change in refractive index in accordance with the wavelength) of the positive lens element provided closest to the object side, miniaturization (slimming down) of the imaging optical system is difficult, and there is a problem with the correction of abaxial aberration such as coma, etc., and the correction of chromatic aberration (axial chromatic aberration and lateral chromatic aberration) being insufficient. In particular, the slimming down of mobile devices having a built-in camera has gained considerable momentum, thereby demanding miniaturization (slimming down) of the imaging optical system to the utmost limit.

### SUMMARY OF THE INVENTION

The present invention has been devised in view of the above-mentioned problems, and provides an imaging optical system having an f-number of approximately 2.0 which enables a large quantity of light to be collected, has a half angle-of-view of 35 degrees or more, can favorably correct abaxial aberration and chromatic aberration (axial chromatic aberration and lateral chromatic aberration), and can meet the demands for miniaturization (slimming down).

According to an aspect of the present invention, an imaging optical system is provided, including a positive first lens element having a convex surface on the object side, a negative second lens element having a concave surface on the image side, a third lens element, a positive fourth lens element, and a negative fifth lens element provided with at least one aspherical surface that has inflection points other than at an optical axis thereof (intersection points other than at the optical axis), in that order from the object side. The following conditions (1) and (2) are satisfied:

−0.80<(r11−r12)/(r11+r12)<−0.20 (1),

and

νd1>60 (2),

wherein r11 designates the radius of curvature of a surface on the object side of the first lens element, r12 designates the radius of curvature of a surface on the image side of the first lens element, and νd1 designates the Abbe number with respect to the d-line of the first lens element.

It is desirable for the following condition (3) to be satisfied:

0.6<f/f12<1.2 (3),

wherein f designates the focal length of the imaging optical system, and f12 designates the combined focal length of the first lens element and the second lens element.

It is desirable for the following condition (4) to be satisfied:

−0.45<f1/f2<−0.10 (4),

wherein f1 designates the focal length of the first lens element, and f2 designates the focal length of the second lens element.

It is desirable for the following condition (5) to be satisfied:

0.05<(r21−r22)/(r21+r22)<0.23 (5),

wherein r21 designates the radius of curvature of a surface on the object side of the second lens element, and r22 designates the radius of curvature of a surface on the image side of the second lens element.

It is desirable for the following condition (6) to be satisfied:

n2>1.8 (6),

wherein n2 designates the refractive index at the d-line of the second lens element.

It is desirable for the following condition (7) to be satisfied:

35<νd1−νd2<80 (7),

wherein νd1 designates the Abbe number with respect to the d-line of the first lens element, and νd2 designates the Abbe number with respect to the d-line of the second lens element.

It is desirable for the following condition (8) to be satisfied:

−2.5<f/f5<−0.8 (8),

wherein f designates the focal length of the imaging optical system, and f5 designates the focal length of the fifth lens element.

It is desirable for the following condition (9) to be satisfied:

0.05<d5/f<0.18 (9),

wherein d5 designates the lens thickness of the fifth lens element, and f designates the focal length of the imaging optical system.

It is desirable for the following condition (10) to be satisfied:

0.5<f/f4<1.7 (10),

wherein f designates the focal length of the imaging optical system, and f4 designates the focal length of the fourth lens element.

It is desirable for the following condition (11) to be satisfied:

0.1<d23/f<0.2 (11),

wherein d23 designates the distance between the second lens element and the third lens element, and f designates the focal length of the imaging optical system.

In the imaging optical system, it is desirable for at least the first lens element to be a glass molded lens element, on which an aspherical surface is formed on each side, and each of the remaining lens elements to be a plastic lens element, on which an aspherical surface is formed on each side.

It is desirable for the following condition (12) to be satisfied:

TL/(2*Ymax)<0.75 (12),

wherein TL designates the distance from the surface on the object side of the first lens element to the imaging plane, and Ymax designates the maximum image height.

According to the present invention, an imaging optical system is provided, having an f-number of approximately 2.0 which enables a large amount quantity of light to be collected, a half angle-of-view of 35 degrees or more, can favorably correct abaxial aberrations and chromatic aberrations (axial chromatic aberration and lateral chromatic aberration), and can meet the demands for miniaturization (slimming down).

The present disclosure relates to subject matter contained in Japanese Patent Application No. 2014-247242 (filed on Dec. 5, 2014) which is expressly incorporated herein in its entirety.

### BRIEF DESCRIPTION OF THE DRAWINGS

The present invention will be discussed below in detail with reference to the accompanying drawings, in which:

FIG. 1 shows a lens arrangement of a first numerical embodiment of the imaging optical system;

FIGS. 2A, 2B, 2C and 2D show various aberrations that occurred in the lens arrangement of FIG. 1;

FIG. 3 shows a lens arrangement of a second numerical embodiment of the imaging optical system;

FIGS. 4A, 4B, 4C and 4D show various aberrations that occurred in the lens arrangement of FIG. 3;

FIG. 5 shows a lens arrangement of a third numerical embodiment of the imaging optical system;

FIGS. 6A, 6B, 6C and 6D show various aberrations that occurred in the lens arrangement of FIG. 5;

FIG. 7 shows a lens arrangement of a fourth numerical embodiment of the imaging optical system;

FIGS. 8A, 8B, 8C and 8D show various aberrations that occurred in the lens arrangement of FIG. 7;

FIG. 9 shows a lens arrangement of a fifth numerical embodiment of the imaging optical system;

FIGS. 10A, 10B, 100 and 10D show various aberrations that occurred in the lens arrangement of FIG. 9;

FIG. 11 shows a lens arrangement of a sixth numerical embodiment of the imaging optical system; and

FIGS. 12A, 12B, 12C and 12D show various aberrations that occurred in the lens arrangement of FIG. 11.

### DESCRIPTION OF THE EMBODIMENTS

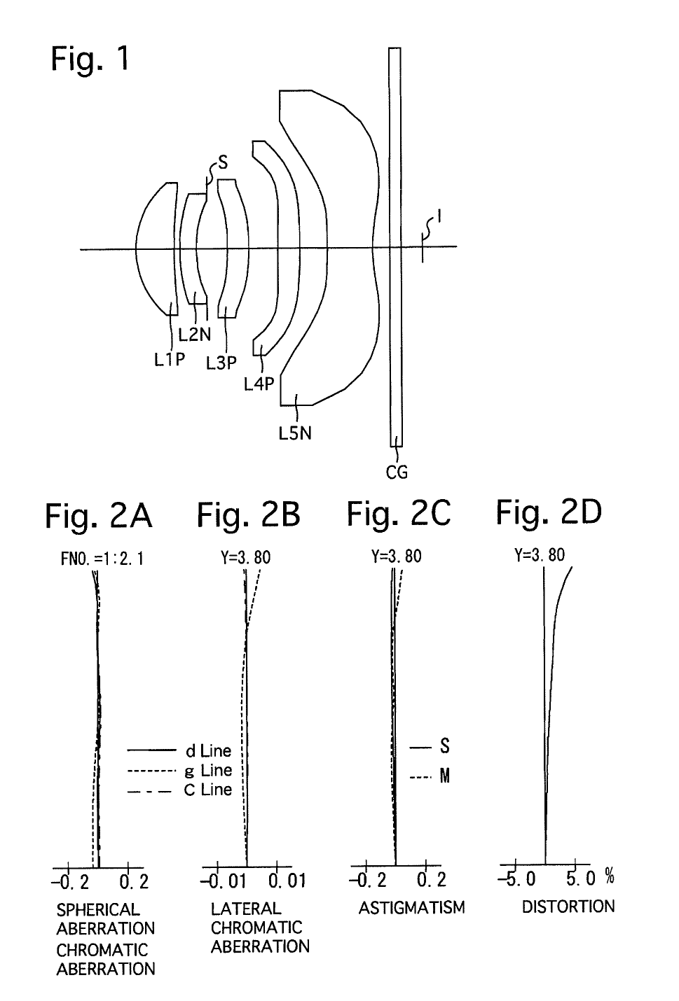

As shown in the lens arrangements of FIGS. 1, 3, 5, 7, 9 and 11, the imaging optical system of the illustrated embodiments is configured of a positive first lens element L1P having a convex surface on the object side (a positive meniscus lens element having a convex surface on the object side), a negative second lens element L2N having a concave surface on the image side (negative meniscus lens element having a convex surface on the object side), a positive third lens element L3P or a negative third lens element L3N, a positive fourth lens element L4P, and a negative fifth lens element L5N, in that order from the object side (a total of five lens elements).

In the first numerical embodiment, each of the first lens element L1P, the second lens element L2N and the third lens element L3P is formed of a glass molded lens element having an aspherical surface on both sides thereof, and each of the remaining lens elements (the fourth lens element L4P and the fifth lens element L5N) is formed of a plastic lens element having an aspherical surface on both sides thereof.

In the second and fourth through sixth numerical embodiments, each of the first lens element L1P and the second lens element L2N is formed of a glass molded lens element having an aspherical surface on both sides thereof, and each of the remaining lens elements (the third lens element L3P, the fourth lens element L4P and the fifth lens element L5N; or the third lens element L3N, the fourth lens element L4P and the fifth lens element L5N) is formed of a plastic lens element having an aspherical surface on both sides thereof.

In the third numerical embodiment, only the first lens element L1P is formed as a glass molded lens element having an aspherical surface on both sides thereof, and each of the remaining lens elements (the second lens element L2N, the third lens element L3N, the fourth lens element L4P and the fifth lens element L5N) is formed of a plastic lens element having an aspherical surface on both sides thereof. Accordingly, by forming at least the first lens element L1P (having a relatively strong refractive power) as a glass molded lens element having an aspherical surface on both sides thereof, deterioration in optical quality occurring due to temperature change can be suppressed.

In the illustrated embodiments of the imaging optical system, the aspherical surfaces on the fifth lens element L5N has inflection points other than at the optical axis (other than at the intersection point at the optical axis).

In the illustrated embodiments of the imaging optical system, a cover glass CG for protecting the imaging surface (imaging plane) I of an image sensor (not shown) is provided behind the fifth lens element L5N.

In the first numerical embodiment, a diaphragm S is provided between the second lens element L2N and the third lens element L3P (immediately behind the second lens element L2N). In each of the second through fourth and the sixth numerical embodiment, a diaphragm S is provided on the periphery of the first lens element L1P and overlaps the first lens element L1P with respect to the optical axis direction. In the fifth numerical embodiment, a diaphragm S is provided between the first lens element L1P and the second lens element L2N (immediately behind the first lens element L1P).

The imaging optical system of the illustrated embodiments is configured of a positive first lens element L1P having a convex surface on the object side (a positive meniscus lens element having a convex surface on the object side), a negative second lens element L2N having a concave surface on the image side (negative meniscus lens element having a convex surface on the object side), a third lens element (L3P or L3N), a positive fourth lens element L4P, and a negative fifth lens element L5N having an aspherical surface, on both sides, including inflection points other than at the optical axis (other than at the intersection point at the optical axis), in that order from the object side. Note that it is possible for an aspherical surface that includes inflections points other than at the optical axis to be formed only on one side of the fifth lens element L5N.

Furthermore, by appropriately setting the profile and the Abbe number (lens material) of the first lens element L1P, which is provided closest to the object side, an imaging optical system having an f-number of approximately 2.0 which enables a large amount quantity of light to be collected, which has a half angle-of-view of 35 degrees or more, which can favorably correct abaxial aberration and chromatic aberration (axial chromatic aberration and lateral chromatic aberration), and can meet the demands for miniaturization (slimming down) can be successfully achieved. Hence, the imaging optical system of the present invention is suitable for use in, e.g., a mobile device (a smart phone, etc.) having a built-in camera, in which miniaturization (slimming down) of the imaging optical system to the utmost limit is demanded.

Condition (1) specifies the profile (shaping factor) of the first lens element L1P. By satisfying condition (1), abaxial aberrations can be favorably corrected, and the imaging optical system (and in turn the entire apparatus onto which the imaging optical system is installed) can be miniaturized (slimmed down).

If the upper limit of condition (1) is exceeded, the radius of curvature of the surface on the object side of the first lens element L1P becomes too small, so that it becomes difficult to favorably correct abaxial aberrations.

If the lower limit of condition (1) is exceeded, the radius of curvature of the surface on the object side of the first lens element L1P becomes too large, so that it becomes difficult to miniaturize (slim down) the imaging optical system (and in turn the entire apparatus onto which the imaging optical system is installed).

Condition (2) specifies the Abbe number with respect to the d-line of the first lens element Lip. By satisfying condition (2), chromatic aberration can be favorably corrected.

If the lower limit of condition (2) is exceeded, correction of the chromatic aberration becomes insufficient.

Condition (3) specifies the ratio of the focal length of the imaging optical system to the combined focal length of the first lens element L1P and the second lens element L2N. By satisfying condition (3), abaxial aberration can be favorably corrected, and the imaging optical system (and in turn the entire apparatus onto which the imaging optical system is installed) can be miniaturized (slimmed down).

If the upper limit of condition (3) is exceeded, the combined focal length of the first lens element L1P and the second lens element L2N becomes too large, so that correcting abaxial aberrations becomes difficult.

If the lower limit of condition (3) is exceeded, the combined focal length of the first lens element L1P and the second lens element L2N becomes too small, so that it becomes difficult to miniaturize (slim down) the imaging optical system (and in turn the entire apparatus onto which the imaging optical system is installed).

Condition (4) specifies the balance of the refractive power between the first lens element L1P and the second lens element L2N. By satisfying condition (4), abaxial aberrations can be favorably corrected, and the imaging optical system (and in turn the entire apparatus onto which the imaging optical system is installed) can be miniaturized (slimmed down).

If the upper limit of condition (4) is exceeded, the refractive power of the first lens element L1P becomes too strong, so that it becomes difficult to favorably correct abaxial aberrations.

If the lower limit of condition (4) is exceeded, the refractive power of the first lens element L1P becomes too weak, so that it becomes difficult to miniaturize (slim down) the imaging optical system (and in turn the entire apparatus onto which the imaging optical system is installed).

Condition (5) specifies the profile (shaping factor) of the second lens element L2N. By satisfying condition (5), abaxial aberrations can be favorably corrected, and the imaging optical system (and in turn the entire apparatus onto which the imaging optical system is installed) can be miniaturized (slimmed down).

If the upper limit of condition (5) is exceeded, the radius of curvature of the surface on the image side of the second lens element L2N becomes too small, so that it becomes difficult to favorably correct abaxial aberrations.

If the lower limit of condition (5) is exceeded, the radius of curvature of the surface on the image side of the second lens element L2N becomes too large, so that it becomes difficult to miniaturize (slim down) the imaging optical system (and in turn the entire apparatus onto which the imaging optical system is installed).

Condition (6) specifies the refractive index at the d-line of the second lens element L2N. By satisfying condition (6), abaxial aberrations can be favorably corrected.

If the lower limit of condition (6) is exceeded, the refractive index at the d-line of the second lens element L2N becomes too small, so that it becomes difficult to favorably correct abaxial aberrations.

Condition (7) specifies the difference in Abbe number with respect to the d-line between the first lens element L1P and the second lens element L2N. By satisfying condition (7), chromatic aberration can be favorably corrected.

If the upper limit of condition (7) is exceeded, the chromatic aberration becomes overcorrected.

If the lower limit of condition (7) is exceeded, the chromatic aberration becomes undercorrected.

Condition (8) specifies the ratio of the focal length of the imaging optical system to the focal length of the fifth lens element L5N. By satisfying condition (8), the telecentric angle and especially abaxial aberrations such as distortion can be favorably corrected, and the imaging optical system (and in turn the entire apparatus onto which the imaging optical system is installed) can be miniaturized (slimmed down).

If the upper limit of condition (8) is exceeded, the refractive power of the fifth lens element L5N becomes too weak, so that it becomes difficult to miniaturize (slim down) the imaging optical system (and in turn the entire apparatus onto which the imaging optical system is installed).

If the lower limit of condition (8) is exceeded, the refractive power of the fifth lens element L5N becomes too strong, so that it becomes difficult to correct the telecentric angle and especially abaxial aberrations, such as distortion.

Condition (9) specifies the ratio of the thickness of the fifth lens element L5N (the distance along the optical axis from the surface closest to the object side on the fifth lens element L5N to the surface closest to the image side on the fifth lens element L5N) to the focal length of the imaging optical system. By satisfying condition (9), the imaging optical system (and in turn the entire apparatus onto which the imaging optical system is installed) can be miniaturized (slimmed down), and a sufficient amount of backfocus and edge thickness of the fifth lens element L5N can be obtained.

If the upper limit of condition (9) is exceeded, the lens thickness of the fifth lens element L5N becomes too large, so that it becomes difficult to miniaturize (slim down) the imaging optical system (and in turn the entire apparatus onto which the imaging optical system is installed), and it becomes difficult to obtain a sufficient backfocus.

If the lower limit of condition (9) is exceeded, the lens thickness of the fifth lens element L5N becomes too small, so that it becomes difficult to obtain a sufficient edge thickness of the fifth lens element L5N.

Condition (10) specifies the ratio of the focal length of the imaging optical system to the focal length of the fourth lens element L4P. By satisfying condition (10), abaxial aberrations can be favorably corrected, and the imaging optical system (and in turn the entire apparatus onto which the imaging optical system is installed) can be miniaturized (slimmed down).

If the upper limit of condition (10) is exceeded, the positive refractive power of the fourth lens element L4P becomes too strong, so that it becomes difficult to correct abaxial aberrations.

If the lower limit of condition (10) is exceeded, the positive refractive power of the fourth lens element L4P becomes too weak, so that it becomes difficult to miniaturize (slim down) the imaging optical system (and in turn the entire apparatus onto which the imaging optical system is installed).

Condition (11) specifies the ratio of the focal length of the imaging optical system to the distance between the second lens element L2N and the third lens element (L3P or L3N). By satisfying condition (11), the imaging optical system (and in turn the entire apparatus onto which the imaging optical system is installed) can be miniaturized (slimmed down), and a sufficient space for providing a stationary diaphragm (not shown in the drawings) between the second lens element L2N and the third lens element (L3P or L3N) can be obtained. This stationary diaphragm (not shown in the drawings) is provided for the purpose of specifying the f-number and for improving the design optical quality (by reducing aberrations and cutting out ghosting), and is a separate component from the diaphragm S shown in the drawings of the illustrated embodiments.

If the upper limit of condition (11) is exceeded, the distance between the second lens element L2N and the third lens element (L3P or L3N) becomes too large, so that it becomes difficult to miniaturize (slim down) the imaging optical system (and in turn the entire apparatus onto which the imaging optical system is installed).

If the lower limit of condition (11) is exceeded, the distance between the second lens element L2N and the third lens element (L3P or L3N) becomes too small, and it becomes difficult to provide the above-mentioned diaphragm, not shown in the drawings, in between the second lens element L2N and the third lens element (L3P or L3N).

Condition (12) specifies the relationship between the distance from the surface on the object side of the first lens element L1P to the imaging surface (plane) I, and the maximum image height; condition (12) indicates the extent by which the height of the imaging optical system can be reduced, thereby indicating the extend of miniaturization (slimming down) of the imaging optical system. By satisfying condition (12), an imaging optical system can be obtained that is suitable for use in, e.g., a mobile device (a smart phone, etc.) having an built-in camera, in which miniaturization (slimming down) of the imaging optical system to the utmost limit is demanded.

Specific first through sixth numerical embodiments will be herein discussed. In the aberration diagrams and the tables, the d-line, g-line and C-line show aberrations at their respective wave-lengths; S designates the sagittal image, M designates the meridional image, R designates the radius of curvature, D designates the lens thickness or distance between lenses, N(d) designates the refractive index at the d-line, and νd designates the Abbe number with respect to the d-line. The unit used for the various lengths is defined in millimeters (mm).

An aspherical surface which is rotationally symmetrical about the optical axis is defined as:

x=cy²/(1+[1−{1+K}c²y²]^{1/2})+A4y⁴+A6y⁶A8y⁸+A10y¹⁰+A12y¹² . . .

wherein ‘c’ designates the curvature (1/r) of the aspherical vertex, ‘y’ designates the distance from the optical axis, ‘K’ designates the conic coefficient, A4 designates a fourth-order aspherical coefficient, A6 designates a sixth-order aspherical coefficient, A8 designates an eighth-order aspherical coefficient, A10 designates a tenth-order aspherical coefficient, A12 designates a twelfth-order aspherical coefficient, and ‘x’ designates the amount of sag.

### Numerical Embodiment 1

FIGS. 1 through 2D and Tables 1 through 3 show a first numerical embodiment of the imaging optical system. FIG. 1 shows a lens arrangement of the first numerical embodiment of the imaging optical system. FIGS. 2A, 2B, 2C and 2D show various aberrations that occurred in the lens arrangement shown in FIG. 1. Table 1 shows the lens surface data, Table 2 shows various data of the imaging optical system, and Table 3 shows aspherical surface data.

The imaging optical system of the first numerical embodiment is configured of a positive first lens element L1P having a convex surface on the object side (a positive meniscus lens element having a convex surface on the object side), a negative second lens element L2N having a concave surface on the image side (negative meniscus lens element having a convex surface on the object side), a positive third lens element L3P, a positive fourth lens element L4P, and a negative fifth lens element L5N, in that order from the object side. Each of the first lens element L1P, the second lens element L2N and the third lens element L3P is configured of a glass molded lens element having an aspherical surface on each side thereof. Each of the fourth lens element L4P and the fifth lens element L5N is configured of a plastic lens element having an aspherical surface on each side thereof. The aspherical surfaces on the fifth lens element L5N have inflection points other than at the optical axis (other than the intersection point at the optical axis). A cover glass CG for protecting the imaging surface I of the image sensor (not shown) is provided behind the fifth lens element L5N. A diaphragm S is provided between the second lens element L2N and the third lens element L3P (immediately behind the second lens element L2N).

TABLE 1
LENS SURFACE DATA

| Surf. No. | R | d | N(d) | ν(d) |
|---|---|---|---|---|
| 1 | 1.563 | 0.69 | 1.49710 | 81.6 |
| 2 | 7.047 | 0.10 | | |
| 3 | 2.949 | 0.30 | 2.00178 | 19.3 |
| 4 | 2.269 | 0.19 | | |
| (Diaphragm) | ∞ | 0.38 | | |
| 5 | −4.264 | 0.39 | 1.49710 | 81.6 |
| 6 | −3.879 | 0.53 | | |
| 7 | 89.670 | 0.40 | 1.63548 | 23.9 |
| 8 | −7.589 | 0.49 | | |
| 9 | −40.000 | 0.82 | 1.54358 | 55.7 |
| 10 | 2.208 | 0.32 | | |
| 11 | ∞ | 0.21 | 1.51680 | 64.2 |
| 12 | ∞ | 0.39 | | |

TABLE 2
IMAGING OPTICAL SYSTEM DATA

| | |
|---|---|
| Focal length of imaging optical system [mm]: | 4.89 |
| f-number | 2.1 |
| Half angle of view [deg]: | 36.6 |
| Maximum image height [mm]: | 3.80 |

TABLE 3
ASPHERICAL SURFACE DATA

| Surf. No. | K | A4 | A6 | A8 | A10 | A12 | A14 | A16 |
|---|---|---|---|---|---|---|---|---|
| 1 | −0.620 | 2.40413E−02 | −1.86371E−02 | 4.62002E−02 | −3.56745E−02 | 1.08064E−02 | | |
| 2 | 0.000 | −5.53938E−02 | 6.95335E−02 | −4.94453E−02 | 1.62197E−02 | | | |
| 3 | 0.000 | −4.60624E−02 | 5.64553E−02 | −2.21916E−02 | 2.83903E−03 | 4.00901E−03 | | |
| 4 | 3.650 | −4.39626E−02 | 2.36322E−02 | −3.11903E−02 | 4.34299E−02 | −2.58945E−02 | | |
| 5 | 0.000 | −6.77111E−02 | −6.60193E−03 | −1.77808E−02 | 8.29069E−02 | −7.18261E−02 | 3.23022E−02 | |
| 6 | 0.000 | −5.76623E−02 | −1.09032E−02 | 1.38792E−04 | 1.99058E−02 | −7.27745E−04 | −1.80026E−03 | |
| 7 | −3.880 | 2.42747E−02 | −6.27913E−02 | 1.48158E−02 | −6.08256E−04 | −3.30844E−04 | 3.94670E−05 | |
| 8 | −4.710 | 3.46179E−02 | −4.57632E−02 | 9.27607E−03 | 1.76398E−04 | −2.53311E−04 | 5.33322E−05 | −7.55000E−06 |
| 9 | −39.700 | −1.37191E−01 | 4.23838E−02 | −6.00100E−03 | 4.31354E−04 | −1.51339E−05 | 2.10000E−07 | |
| 10 | −10.650 | −5.80715E−02 | 1.18246E−02 | −1.58607E−03 | 1.00829E−04 | −2.86581E−06 | −7.26000E−08 | |

### Numerical Embodiment 2

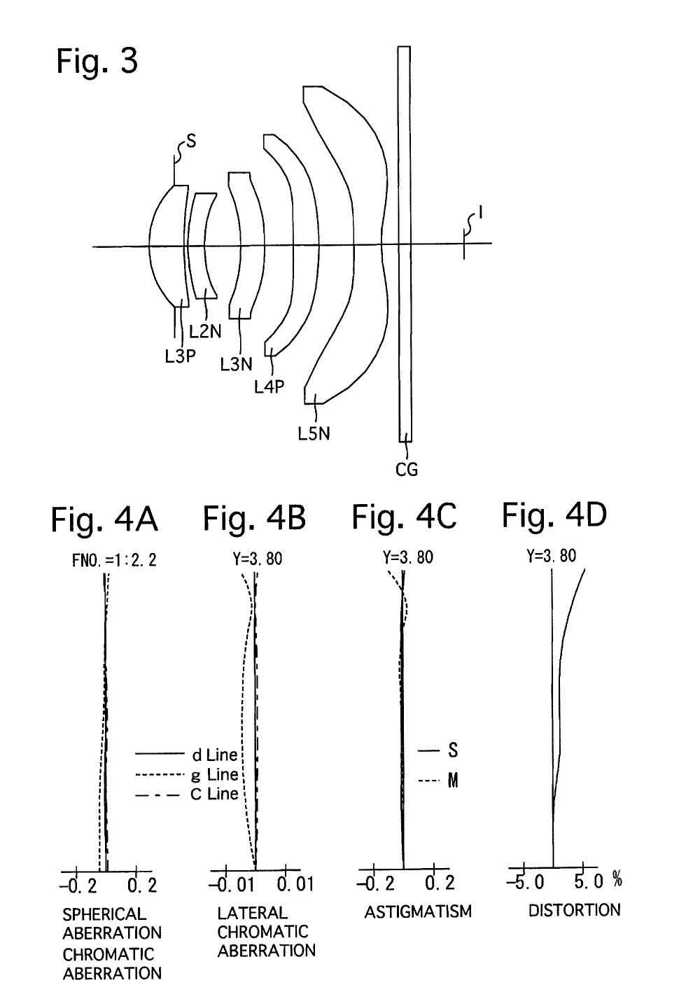

FIGS. 3 through 4D and Tables 4 through 6 show a second numerical embodiment of the imaging optical system. FIG. 3 shows a lens arrangement of the second numerical embodiment of the imaging optical system. FIGS. 4A, 4B, 4C and 4D show various aberrations that occurred in the lens arrangement shown in FIG. 3. Table 4 shows the lens surface data, Table 5 shows various data of the imaging optical system, and Table 6 shows aspherical surface data.

The fundamental lens arrangement of the second numerical embodiment is the same as that of the first numerical embodiment except for the following features:

(1) The positive third lens element L3P is replaced with a negative third lens element L3N.

(2) The negative third lens element L3N is configured of a plastic lens element having an aspherical surface formed on each side thereof instead of being configured of a glass molded lens element.

(3) The diaphragm S is provided on the periphery of the first lens element L1P and overlaps the first lens element L1P with respect to the optical axis direction.

TABLE 4
LENS SURFACE DATA

| Surf. No. | R | d | N(d) | ν(d) |
|---|---|---|---|---|
| (Diaphragm) | ∞ | −0.45 | | |
| 1 | 1.593 | 0.63 | 1.55532 | 71.7 |
| 2 | 5.816 | 0.07 | | |
| 3 | 3.036 | 0.30 | 2.00178 | 19.3 |
| 4 | 2.244 | 0.66 | | |
| 5 | −3.631 | 0.44 | 1.54358 | 55.7 |
| 6 | −3.874 | 0.52 | | |
| 7 | −36.863 | 0.47 | 1.63548 | 23.9 |
| 8 | −4.261 | 0.64 | | |
| 9 | 30.712 | 0.50 | 1.54358 | 55.7 |
| 10 | 2.065 | 0.32 | | |
| 11 | ∞ | 0.21 | 1.51680 | 64.2 |
| 12 | ∞ | 0.50 | | |

TABLE 5
IMAGING OPTICAL SYSTEM DATA

| | |
|---|---|
| Focal length of imaging optical system [mm]: | 4.90 |
| f-number | 2.2 |
| Half angle of view [deg]: | 35.9 |
| Maximum image height [mm]: | 3.80 |

TABLE 6
ASPHERICAL SURFACE DATA

| Surf. No. | K | A4 | A6 | A8 | A10 | A12 | A14 | A16 |
|---|---|---|---|---|---|---|---|---|
| 1 | −0.620 | 2.74176E−02 | −1.21404E−02 | 4.31776E−02 | −3.46015E−02 | 1.29067E−02 | | |
| 2 | 0.000 | −5.01084E−02 | 7.56220E−02 | −4.88195E−02 | 1.37944E−02 | | | |
| 3 | 0.000 | −4.09475E−02 | 5.69240E−02 | −2.77109E−02 | 4.72425E−03 | −7.93702E−04 | | |
| 4 | 3.650 | −3.37625E−02 | 1.53897E−02 | −2.67995E−02 | 4.00179E−02 | −3.52618E−02 | | |
| 5 | 0.000 | −7.16915E−02 | −7.28681E−03 | −9.43659E−03 | 8.69549E−02 | −7.52077E−02 | 2.55693E−02 | |
| 6 | 0.000 | −6.07133E−02 | −9.00010E−03 | −1.33133E−03 | 1.92975E−02 | −7.66477E−04 | −1.70013E−03 | |
| 7 | −3.880 | 2.24826E−02 | −6.16784E−02 | 1.42720E−02 | −4.09030E−04 | −2.05610E−04 | 3.94670E−05 | |
| 8 | −9.550 | 3.69290E−02 | −4.56838E−02 | 9.26678E−03 | 1.58790E−04 | −2.57015E−04 | 5.33141E−05 | −7.45000E−06 |
| 9 | −34.000 | −1.40916E−01 | 4.25385E−02 | −5.99236E−03 | 4.30877E−04 | −1.49842E−05 | 2.10000E−07 | |
| 10 | −12.570 | −6.04197E−02 | 1.14849E−02 | −1.56049E−03 | 1.07603E−04 | −2.55240E−06 | −7.26000E−08 | |

### Numerical Embodiment 3

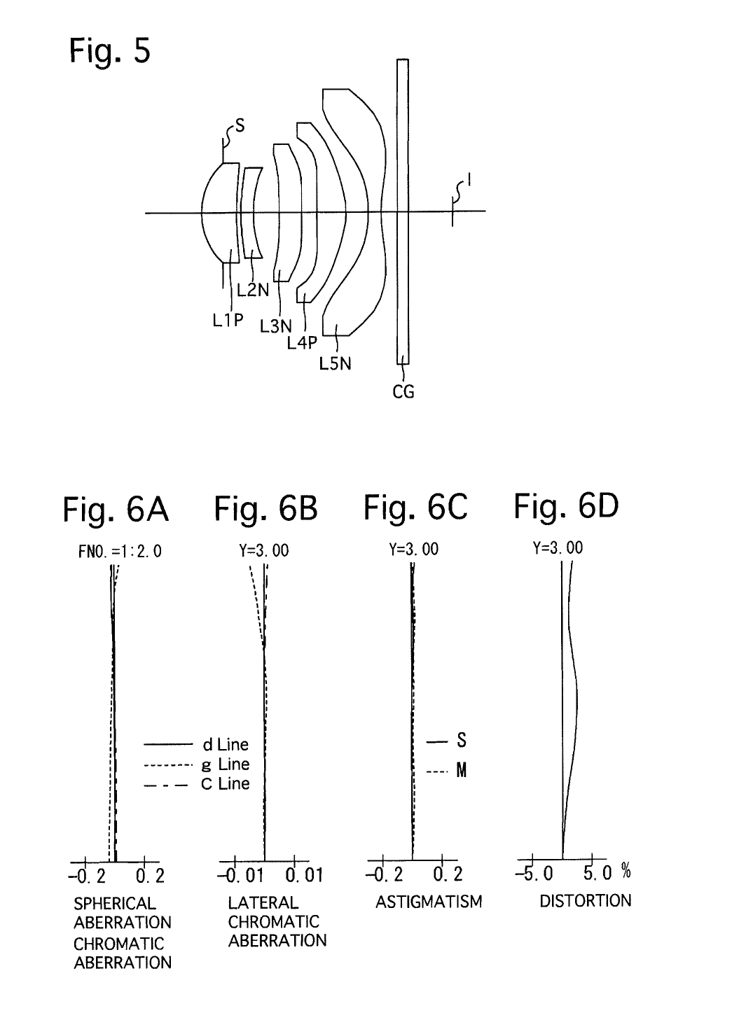

FIGS. 5 through 6D and Tables 7 through 9 show a third numerical embodiment of the imaging optical system. FIG. 5 shows a lens arrangement of the third numerical embodiment of the imaging optical system. FIGS. 6A, 6B, 6C and 6D show various aberrations that occurred in the lens arrangement shown in FIG. 5. Table 7 shows the lens surface data, Table 8 shows various data of the imaging optical system, and Table 9 shows aspherical surface data.

The fundamental lens arrangement of the third numerical embodiment is the same as that of the first numerical embodiment except for the following features:

(1) The positive third lens element L3P is replaced with a negative third lens element L3N.

(2) The negative second lens element L2N and the negative third lens element L3N are configured of a plastic lens element having an aspherical surface formed on each side thereof instead of being configured of a glass molded lens element.

(3) The diaphragm S is provided on the periphery of the first lens element L1P and overlaps the first lens element L1P with respect to the optical axis direction.

TABLE 7
LENS SURFACE DATA

| Surf. No. | R | d | N(d) | ν(d) |
|---|---|---|---|---|
| (Diaphragm) | ∞ | −0.38 | | |
| 1 | 1.261 | 0.62 | 1.43700 | 95.1 |
| 2 | 3.848 | 0.08 | | |
| 3 | 2.677 | 0.23 | 1.64250 | 22.5 |
| 4 | 2.259 | 0.47 | | |
| 5 | 68.166 | 0.41 | 1.54358 | 55.7 |
| 6 | 22.479 | 0.28 | | |
| 7 | 19.411 | 0.53 | 1.54358 | 55.7 |
| 8 | −1.467 | 0.41 | | |
| 9 | −2.218 | 0.23 | 1.53484 | 55.7 |
| 10 | 2.026 | 0.30 | | |
| 11 | ∞ | 0.21 | 1.51680 | 64.2 |
| 12 | ∞ | 0.43 | | |

TABLE 8
IMAGING OPTICAL SYSTEM DATA

| | |
|---|---|
| Focal length of imaging optical system [mm]: | 3.67 |
| f-number | 2.0 |
| Half angle of view [deg]: | 38.8 |
| Maximum image height [mm]: | 3.00 |

TABLE 9
ASPHERICAL SURFACE DATA

| Surf. No. | K | A4 | A6 | A8 | A10 | A12 | A14 |
|---|---|---|---|---|---|---|---|
| 1 | 0.250 | −1.74729E−02 | 1.70074E−02 | −9.54742E−02 | 1.46317E−01 | −9.05270E−02 | |
| 2 | 0.000 | −1.62292E−01 | 2.16026E−01 | −1.96453E−01 | 8.81008E−02 | −4.96512E−02 | |
| 3 | 0.000 | −1.80824E−01 | 1.21784E−01 | 5.16938E−02 | −1.89320E−01 | 6.15901E−02 | |
| 4 | −2.600 | −8.95000E−03 | 7.51112E−04 | 3.62914E−01 | −5.44598E−01 | 3.69145E−01 | |
| 5 | 0.000 | −1.30474E−01 | 2.73838E−02 | −2.67714E−03 | −2.06132E−03 | 2.00560E−02 | −5.07942E−03 |
| 6 | 0.000 | −1.43616E−01 | −7.33272E−02 | 1.85864E−01 | −2.68885E−01 | 2.02689E−01 | −5.29171E−02 |
| 7 | −16.500 | −2.05990E−02 | −6.29936E−02 | 3.53786E−02 | −3.72616E−02 | 1.44732E−02 | −1.71123E−03 |
| 8 | −6.220 | −3.18532E−02 | 5.07381E−02 | −4.10994E−02 | 1.55540E−02 | −4.38878E−03 | 6.78210E−04 |
| 9 | −4.600 | −1.47538E−01 | 4.95245E−02 | −1.53350E−03 | −1.01930E−03 | 8.15947E−05 | 2.09855E−06 |
| 10 | −16.200 | −9.20744E−02 | 3.55758E−02 | −1.01329E−02 | 9.95952E−04 | 5.40573E−05 | −1.06036E−05 |

### Numerical Embodiment 4

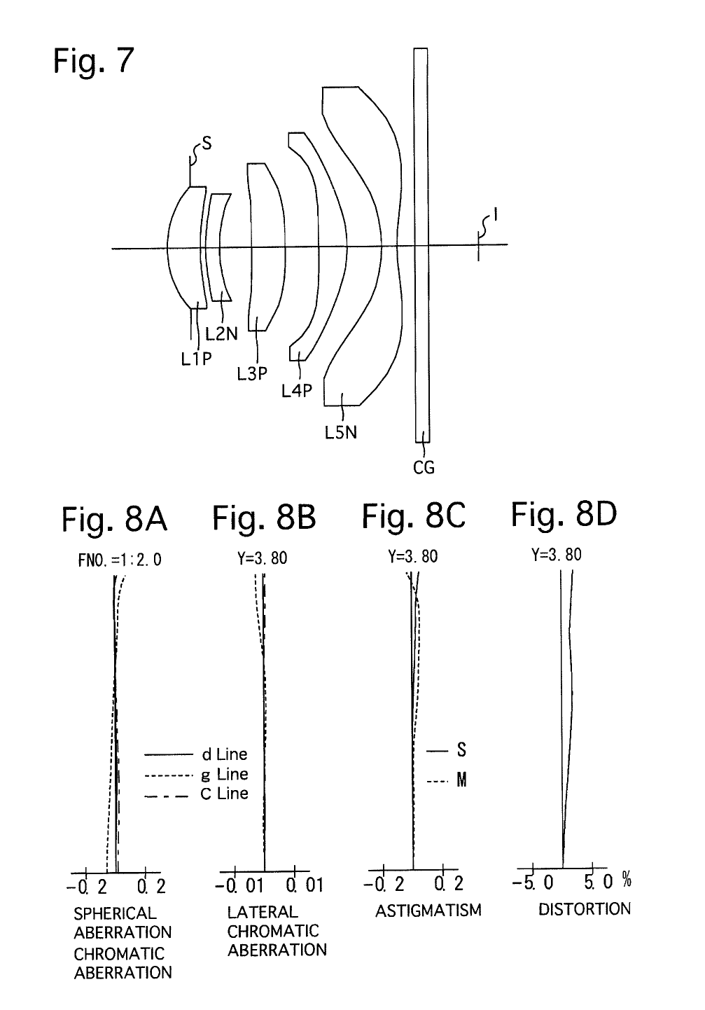

FIGS. 7 through 8D and Tables 10 through 12 show a fourth numerical embodiment of the imaging optical system. FIG. 7 shows a lens arrangement of the fourth numerical embodiment of the imaging optical system. FIGS. 8A, 8B, 8C and 8D show various aberrations that occurred in the lens arrangement shown in FIG. 7. Table 10 shows the lens surface data, Table 11 shows various data of the imaging optical system, and Table 12 shows aspherical surface data.

The fundamental lens arrangement of the fourth numerical embodiment is the same as that of the first numerical embodiment except for the following features:

(1) The positive third lens element L3P is configured of a plastic lens element having an aspherical surface formed on each side thereof instead of being configured of a glass molded lens element.

(2) The diaphragm S is provided on the periphery of the first lens element L1P and overlaps the first lens element L1P with respect to the optical axis direction.

TABLE 10
LENS SURFACE DATA

| Surf. No. | R | d | N(d) | ν(d) |
|---|---|---|---|---|
| (Diaphragm) | ∞ | −0.42 | | |
| 1 | 1.732 | 0.59 | 1.61881 | 63.9 |
| 2 | 3.348 | 0.10 | | |
| 3 | 3.047 | 0.25 | 1.92286 | 20.9 |
| 4 | 2.468 | 0.58 | | |
| 5 | 176.575 | 0.62 | 1.54358 | 55.7 |
| 6 | −9.206 | 0.60 | | |
| 7 | −22.902 | 0.52 | 1.54358 | 55.7 |
| 8 | −1.950 | 0.63 | | |
| 9 | −2.644 | 0.28 | 1.53484 | 55.7 |
| 10 | 2.937 | 0.33 | | |
| 11 | ∞ | 0.25 | 1.51680 | 64.2 |
| 12 | ∞ | 0.45 | | |

TABLE 11
IMAGING OPTICAL SYSTEM DATA

| | |
|---|---|
| Focal length of imaging optical system [mm]: | 4.51 |
| f-number | 2.0 |
| Half angle of view [deg]: | 39.6 |
| Maximum image height [m]: | 3.80 |

TABLE 12
ASPHERICAL SURFACE DATA

| Surf. No. | K | A4 | A6 | A8 | A10 | A12 | A14 |
|---|---|---|---|---|---|---|---|
| 1 | 0.250 | −5.41994E−03 | 1.39544E−02 | −1.97156E−02 | 1.33320E−02 | −2.25326E−03 | |
| 2 | 0.000 | −8.98760E−02 | 5.90031E−02 | −2.77272E−02 | 2.74871E−02 | −1.47385E−02 | |
| 3 | 0.000 | −1.03143E−01 | 5.03796E−02 | 2.81700E−02 | −1.99655E−02 | −6.57424E−03 | |
| 4 | −2.420 | −8.44353E−03 | 2.88236E−02 | 8.09801E−02 | −7.37731E−02 | 2.13962E−02 | |
| 5 | 0.000 | −4.63079E−02 | 5.65708E−03 | −1.94220E−03 | 2.76443E−03 | 2.69594E−03 | −1.22427E−03 |
| 6 | 0.000 | −4.83435E−02 | −2.23603E−02 | 3.44412E−02 | −3.20867E−02 | 1.44439E−02 | −2.21187E−03 |
| 7 | −16.500 | −1.24510E−02 | −1.19387E−02 | 6.21211E−03 | −4.15969E−03 | 1.06576E−03 | −9.29504E−05 |
| 8 | −6.220 | −3.12833E−02 | 1.78693E−02 | −6.87104E−03 | 1.83112E−03 | −3.26888E−04 | 2.59802E−05 |
| 9 | −0.690 | −4.84049E−02 | 1.37362E−02 | −3.99955E−04 | −1.21292E−04 | 6.53939E−06 | 2.37053E−07 |
| 10 | −18.290 | −4.68869E−02 | 1.17338E−02 | −1.91790E−03 | 1.09185E−04 | 3.68003E−06 | −4.16305E−07 |

### Numerical Embodiment 5

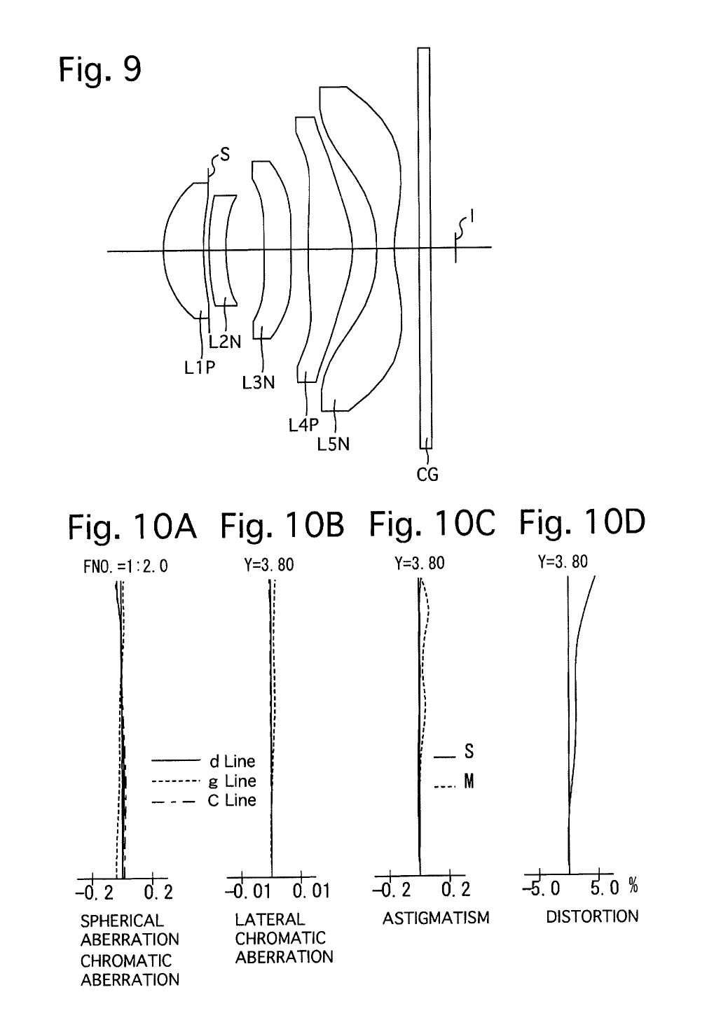

FIGS. 9 through 10D and Tables 13 through 15 show a fifth numerical embodiment of the imaging optical system. FIG. 9 shows a lens arrangement of the fifth numerical embodiment of the imaging optical system. FIGS. 10A, 10B, 100 and 10D show various aberrations that occurred in the lens arrangement shown in FIG. 9. Table 13 shows the lens surface data, Table 14 shows various data of the imaging optical system, and Table 15 shows aspherical surface data.

The fundamental lens arrangement of the fifth numerical embodiment is the same as that of the first numerical embodiment except for the following feature:

(1) The positive third lens element L3P is replaced with a negative third lens element L3N.

(2) The negative third lens element L3N is configured of a plastic lens element having an aspherical surface formed on each side thereof instead of being configured of a glass molded lens element.

(3) The diaphragm S is provided between the first lens element L1P and the second lens element L2N (immediately behind the first lens element L1P).

TABLE 13
LENS SURFACE DATA

| Surf. No. | R | d | N(d) | ν(d) |
|---|---|---|---|---|
| 1 | 1.670 | 0.72 | 1.59201 | 67.0 |
| 2 | 4.129 | 0.09 | | |
| (Diaphragm) | ∞ | 0.01 | | |
| 3 | 4.297 | 0.30 | 2.00178 | 19.3 |
| 4 | 3.208 | 0.70 | | |
| 5 | −41.591 | 0.49 | 1.54358 | 55.7 |
| 6 | 27.075 | 0.32 | | |
| 7 | 12.414 | 0.81 | 1.54358 | 55.7 |
| 8 | −1.655 | 0.44 | | |
| 9 | −2.885 | 0.31 | 1.54358 | 55.7 |
| 10 | 2.059 | 0.45 | | |
| 11 | ∞ | 0.21 | 1.51680 | 64.2 |
| 12 | ∞ | 0.35 | | |

TABLE 14
IMAGING OPTICAL SYSTEM DATA

| | |
|---|---|
| Focal length of imaging optical system [mm]: | 4.52 |
| f-number | 2.0 |
| Half angle of view [deg]: | 38.8 |
| Maximum image height [mm]: | 3.80 |

TABLE 15
ASPHERICAL SURFACE DATA

| Surf. No. | K | A4 | A6 | A8 | A10 | A12 | A14 |
|---|---|---|---|---|---|---|---|
| 1 | 0.000 | −1.42904E−03 | 1.43249E−02 | −1.47569E−02 | 8.99840E−03 | −1.72482E−03 | |
| 2 | 0.000 | −4.02096E−02 | −6.99364E−03 | 4.45983E−02 | −3.76024E−02 | 1.10320E−02 | |
| 3 | 0.000 | −3.32124E−02 | 1.02212E−02 | 3.02392E−02 | −2.44735E−02 | 6.12396E−03 | |
| 4 | −1.580 | 2.03352E−02 | 8.76620E−03 | 9.00620E−02 | −1.07750E−01 | 5.73646E−02 | |
| 5 | 0.000 | −7.12643E−02 | −2.58260E−02 | 7.96813E−02 | −9.18706E−02 | 4.94930E−02 | −1.02217E−02 |
| 6 | 0.000 | −7.97396E−02 | −1.13240E−02 | 2.13550E−02 | −2.09579E−02 | 1.05126E−02 | −1.79904E−03 |
| 7 | 0.000 | 2.43913E−03 | −6.95089E−03 | −3.22725E−03 | 1.53148E−03 | −1.79634E−04 | 4.61788E−06 |
| 8 | −5.060 | 1.10520E−02 | 5.90059E−03 | −3.21679E−03 | 3.08792E−04 | 3.33382E−05 | −4.54972E−06 |
| 9 | 0.000 | −4.46393E−02 | 1.17704E−02 | 1.21016E−04 | −1.27673E−04 | 1.92103E−06 | 5.84174E−07 |
| 10 | −15.760 | −4.96226E−02 | 1.26319E−02 | −2.35831E−03 | 1.94316E−04 | −2.78815E−06 | −2.73415E−07 |

### Numerical Embodiment 6

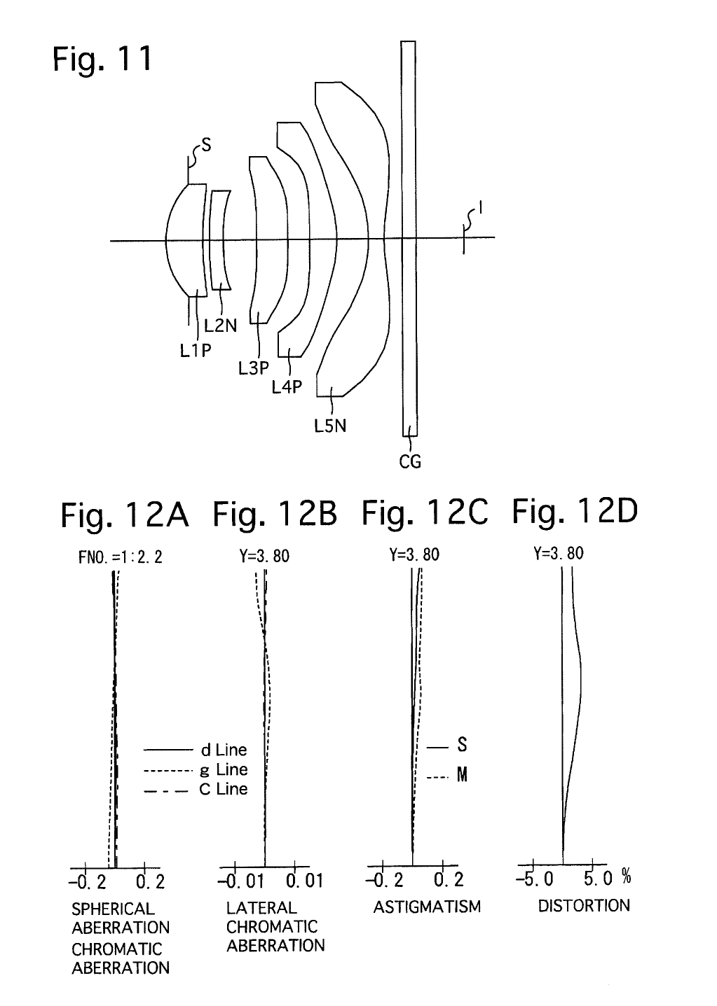

FIGS. 11 through 12D and Tables 16 through 18 show a sixth numerical embodiment of the imaging optical system. FIG. 11 shows a lens arrangement of the sixth numerical embodiment of the imaging optical system. FIGS. 12A, 12B, 12C and 12D show various aberrations that occurred in the lens arrangement shown in FIG. 11. Table 16 shows the lens surface data, Table 17 shows various data of the imaging optical system, and Table 18 shows aspherical surface data.

The fundamental lens arrangement of the sixth numerical embodiment is the same as that of the fourth numerical embodiment.

TABLE 16
LENS SURFACE DATA

| Surf. No. | R | d | N(d) | ν(d) |
|---|---|---|---|---|
| (Diaphragm) | ∞ | −0.41 | | |
| 1 | 1.490 | 0.65 | 1.49710 | 81.6 |
| 2 | 4.066 | 0.12 | | |
| 3 | 5.404 | 0.25 | 1.82115 | 24.1 |
| 4 | 3.925 | 0.60 | | |
| 5 | −82.724 | 0.58 | 1.54358 | 55.7 |
| 6 | −15.157 | 0.40 | | |
| 7 | −29.749 | 0.50 | 1.54358 | 55.7 |
| 8 | −2.015 | 0.58 | | |
| 9 | −2.523 | 0.28 | 1.53484 | 55.7 |
| 10 | 2.785 | 0.33 | | |
| 11 | ∞ | 0.25 | 1.51680 | 64.2 |
| 12 | ∞ | 0.45 | | |

TABLE 17
IMAGING OPTICAL SYSTEM DATA

| | |
|---|---|
| Focal length of imaging optical system [mm]: | 4.47 |
| f-number | 2.2 |
| Half angle of view [deg]: | 39.9 |
| Maximum image height [mm]: | 3.80 |

TABLE 18
ASPHERICAL SURFACE DATA

| Surf. No. | K | A4 | A6 | A8 | A10 | A12 | A14 |
|---|---|---|---|---|---|---|---|
| 1 | 0.250 | −1.51149E−02 | 2.06953E−02 | −3.22643E−02 | 1.85393E−02 | −4.83631E−03 | |
| 2 | 0.000 | −8.72743E−02 | 6.13007E−02 | −4.91661E−02 | 3.89256E−02 | −9.80564E−03 | |
| 3 | 0.000 | −8.85378E−02 | 6.20190E−02 | 2.25715E−02 | −2.74249E−02 | 8.65268E−03 | |
| 4 | −2.400 | −1.15882E−02 | 5.87268E−02 | 7.96351E−02 | −1.07817E−01 | 7.04775E−02 | |
| 5 | 0.000 | −6.40181E−02 | 1.16878E−02 | −2.90547E−03 | −5.76557E−04 | 3.88427E−03 | −1.13638E−03 |
| 6 | 0.000 | −7.72811E−02 | −2.22288E−02 | 3.45879E−02 | −3.08437E−02 | 1.47794E−02 | −2.40803E−03 |
| 7 | −16.600 | −2.00675E−02 | −2.17818E−02 | 5.12335E−03 | −3.97902E−03 | 1.40713E−03 | −1.55036E−04 |
| 8 | −5.720 | 4.98262E−03 | 8.17703E−03 | −7.14260E−03 | 2.15276E−03 | −2.87687E−04 | 1.24204E−05 |
| 9 | −1.700 | −4.54665E−02 | 1.42421E−02 | −5.92615E−04 | −1.32390E−04 | 7.26952E−06 | 3.38416E−07 |
| 10 | −20.000 | −3.93861E−02 | 9.23706E−03 | −1.57305E−03 | 9.42549E−05 | 1.15176E−06 | −2.01099E−07 |

The numerical values of each condition for each of the first through sixth numerical embodiments are shown in Table 19.

TABLE 19

| | Embod. 1 | Embod. 2 | Embod. 3 |
|---|---|---|---|
| Cond. (1) | −0.64 | −0.57 | −0.51 |
| Cond. (2) | 81.56 | 71.68 | 95.10 |
| Cond. (3) | 1.02 | 1.00 | 0.85 |
| Cond. (4) | −0.31 | −0.36 | −0.14 |
| Cond. (5) | 0.13 | 0.15 | 0.08 |
| Cond. (6) | 2.00 | 2.00 | 1.64 |
| Cond. (7) | 62.24 | 52.36 | 72.64 |
| Cond. (8) | −1.28 | −1.20 | −1.89 |
| Cond. (9) | 0.17 | 0.10 | 0.06 |
| Cond. (10) | 0.44 | 0.65 | 1.45 |
| Cond. (11) | 0.12 | 0.13 | 0.13 |
| Cond. (12) | 0.69 | 0.69 | 0.70 |
| | Embod. 4 | Embod. 5 | Embod. 6 |
| Cond. (1) | −0.32 | −0.42 | −0.46 |
| Cond. (2) | 63.85 | 67.02 | 81.56 |
| Cond. (3) | 0.71 | 0.86 | 0.86 |
| Cond. (4) | −0.29 | −0.29 | −0.23 |
| Cond. (5) | 0.10 | 0.15 | 0.16 |
| Cond. (6) | 1.92 | 2.00 | 1.82 |
| Cond. (7) | 42.97 | 47.70 | 57.50 |
| Cond. (8) | −1.76 | −2.09 | −1.84 |
| Cond. (9) | 0.06 | 0.07 | 0.06 |
| Cond. (10) | 1.16 | 1.65 | 1.13 |
| Cond. (11) | 0.13 | 0.15 | 0.13 |
| Cond. (12) | 0.68 | 0.68 | 0.66 |

As can be understood from Table 19, the first through sixth embodiments satisfy conditions (1) and (2). Furthermore, as can be understood from the aberration diagrams, the various aberrations are suitably corrected.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. An imaging optical system comprising a positive first lens element having a convex surface on the object side, a negative second lens element having a concave surface on the image side, a third lens element, a positive fourth lens element, and a negative fifth lens element provided with at least one aspherical surface that has inflection points other than at an optical axis thereof, in that order from the object side, and
wherein the following conditions (1) and (2) are satisfied:
−0.80<(r11−r12)/(r11+r12)<−0.20 (1),
and
νd1>60 (2),
wherein
r11 designates the radius of curvature of a surface on the object side of said first lens element,
r12 designates the radius of curvature of a surface on the image side of said first lens element, and
νd1 designates the Abbe number with respect to the d-line of said first lens element.

2. The imaging optical system according to claim 1, wherein the following condition (3) is satisfied:
0.6<f/f12<1.2 (3),
wherein
f designates the focal length of the imaging optical system, and
f12 designates the combined focal length of said first lens element and said second lens element.

3. The imaging optical system according to claim 1, wherein the following condition (4) is satisfied:
−0.45<f1/f2<−0.10 (4),
wherein
f1 designates the focal length of said first lens element, and
f2 designates the focal length of said second lens element.

4. The imaging optical system according to claim 1, wherein the following condition (5) is satisfied:
0.05<(r21−r22)/(r21+r22)<0.23 (5),
wherein
r21 designates the radius of curvature of a surface on the object side of said second lens element, and
r22 designates the radius of curvature of a surface on the image side of said second lens element.

5. The imaging optical system according to claim 1, wherein the following condition (6) is satisfied:
n2>1.8 (6),
wherein
n2 designates the refractive index at the d-line of said second lens element.

6. The imaging optical system according to claim 1, wherein the following condition (7) is satisfied:
35<νd1−νd2<80 (7),
wherein
νd1 designates the Abbe number with respect to the d-line of said first lens element, and
νd2 designates the Abbe number with respect to the d-line of said second lens element.

7. The imaging optical system according to claim 1, wherein the following condition (8) is satisfied:
−2.5<f/f5<−0.8 (8),
wherein
f designates the focal length of the imaging optical system, and
f5 designates the focal length of the fifth lens element.

8. The imaging optical system according to claim 1, wherein the following condition (9) is satisfied:
0.05<d5/f<0.18 (9),
wherein
d5 designates the lens thickness of said fifth lens element, and
f designates the focal length of said imaging optical system.

9. The imaging optical system according to claim 1, wherein the following condition (10) is satisfied:
0.5<f/f4<1.7 (10),
wherein
f designates the focal length of said imaging optical system, and
f4 designates the focal length of said fourth lens element.

10. The imaging optical system according to claim 1, wherein the following condition (11) is satisfied:
0.1<d23/f<0.2 (11),
wherein
d23 designates the distance between said second lens element and said third lens element, and
f designates the focal length of said imaging optical system.

11. The imaging optical system according to claim 1, wherein at least said first lens element comprises a glass molded lens element, on which an aspherical surface is formed on each side, and each of remaining lens elements comprises a plastic lens element, on which an aspherical surface is formed on each side.

12. The imaging optical system according to claim 1, wherein the following condition (12) is satisfied:
TL/(2*Ymax)<0.75 (12),
wherein
TL designates the distance from the surface on the object side on said first lens element to the imaging plane, and
Ymax designates the maximum image height.
